(19) United States
(12) Patent Application Publication
(10) Pub. No.: US 2005/0000359 A1
(43) Pub. Date: Jan. 6, 2005

(54) Method for the separation of gaseous components from technical gases by means of ethylene glycol dimethyl ethers at low temperatures

(76) Inventors: Michael Wyschofsky, Dortmund (DE); Dirk Hoberg, Dormund (DE)

Correspondence Address: Donald A Schurr;Marshall & Melhorn, Four Seagate - 8th Floor, Toledo, OH, 43604, US

(21) Appl. No.: 10/484,972

(22) PCT Filed: Jul. 17, 2002
(86) PCT No.: PCT/EP02/07915

(30) Foreign Application Priority Data
Jul. 27, 2001 (DE) 101 36 484.9

(51) Int. Cl. B01D 53/14

(52) U.S. Cl. 95/230

(57) ABSTRACT

The invention relates to a process for removing components from technical gases, said components being scrubbed from the technical gas, the scrubbing agent laden with said components being purified in a separate regeneration process and the scrubbing to remove these components taking place at a temperature of +15° to −60° C. The scrubbing agent is ethylene glycol dimethyl ether (EGDME) or a mixture of various EGDMEs, said scrubbing agent having a solidification point of <−30° C., a boiling temperature of <275° C. at normal pressure and a molar mass of <230 g/mol.

The invention relates to a process for removing gas components from technical gases, such as natural gas, synthesis gas and process gas, said components being removed from the technical gas by low-temperature scrubbing using ethylene glycol dimethyl ether, hereinafter referred to as EGDME.

The aim of the invention is to provide an extremely economical process for removing undesired gas components, which in this case denote H₂O, H₂S, CO₂, COS, HCN, CS₂, NH₃, mercaptan, thiophene, carbonyl, naphthalene, paraffin (C3⁺) and organic hydrocarbons but which need not all be present simultaneously, from technical gases such as natural gas, synthesis gas as required for methanol and ammonia production, and process gases emanating from the gasification of coal, oil and waste materials.

The aim of the invention is achieved by removing said gas components in a gas scrubbing process at +15 to −60° C., using as scrubbing agent an EGDME or a mixture of various EGDMEs, said scrubbing agent having a solidification point of −30° C., a boiling point of <275° C. at normal pressure and a molar mass of <230 g/mol; the scrubbing agent laden with the gas components is separated from said components in a separate regeneration step. During scrubbing the gas components are physically dissolved in or absorbed by said agent, respectively, hence they do not form any chemical compound with the scrubbing agent.

In an embodiment of the invention, the scrubbing process uses mono-/di-/tri- and tetra-EGDME or mixtures thereof. The preferred agents are di- and tri-EGDME or mixtures thereof that have an average molar mass of 134 to 178 g/mol.

A further embodiment of the process provides for a scrubbing at a temperature of −20° C. to −40° C. to remove the gas components.

Compared to other similar processes, the process according to the invention has the advantage that only small quantities of scrubbing agent must be circulated in the scrubbing cycle, which permits considerable savings that are achieved in the rating of pumps and their piping and in the lower consumption of electric power required for the circulation pumps.

Compared to conventional scrubbing agents that are used at higher temperatures, the scrubbing agent in accordance with the invention permits extremely small diameters of the scrubbers, so that it is not necessary to provide for a separation of scrubbing agent portions evaporated during the scrubbing process, from the purified technical gas in additional process steps that take place after scrubbing.

In view of the above-mentioned technological reasons, the process described in the invention is particularly suited for plants with a high capacity which consequently may even be designed as single-train plant where normally multi-train configurations would be required on account of the necessary dimensions.

Moreover, this process has the advantage that a very high degree of purity of the technical gas is feasible, i.e. up to the ppm range.

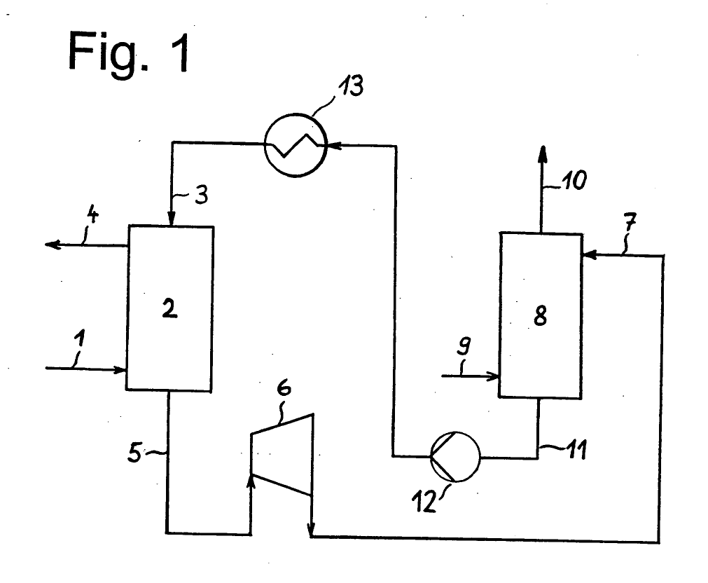

The process in accordance with the invention is described in detail on the basis of FIG. 1 in conjunction with the example calculated in Table 1. In this particular case, gas scrubbing unit (2) and regeneration unit (8) are merely shown in block-type manner to represent the multitude of configurations that are feasible. The unpurified technical gas stream (1) is cleaned with scrubbing agent (3) in scrubber (2). The cleaned technical gas stream (4) leaves gas scrubber (2). The laden scrubbing agent (5) is withdrawn from gas scrubber (2) and then piped to expansion turbine (6) in which the agent is flashed and thus cooled. The expanded scrubbing agent is piped to regeneration unit (8) in which the gas components separated in scrubber (2) are partly set free as a result of the expansion and partly stripped from the agent with the aid of stripping gas (9), which in this particular case is nitrogen. The gas components separated are piped via line 10 for further processing. The separated scrubbing agent (11) is re-compressed in compressing unit (12) to reach the required pressure and it is aftercooled in cooler (13) to reach the required temperature.

The example referred to in Table 1 is based on the task that a scrubbing agent EGDME with a molar mass of 178 g/mol is used to remove CO₂ as the undesired gas component.

| Stream | Process-stream | | Tem- | | CO₂ | |
|---|---|---|---|---|---|---|
| No. | flow rate | | perature | Pressure | content | |
| 1 | 21 400 | kmol/h | −15° C. | 44.8 (bar_{abs}) | 17.6 | molar % |
| 4 | 16 750 | kmol/h | −25° C. | 44.6 (bar_{abs}) | 500 | ppm by vol. |
| 10 | 5 600 | kmol/h | −24° C. | 1.5 (bar_{abs}) | 65 | molar % |
| 3 | 1 150 | m³/h | −25° C. | 46 (bar_{abs}) | — | |
| 5 | 1 300 | m³/h | −18° C. | 44 (bar_{abs}) | 130 | kg/m³ |

If further condensable components separated in scrubber (2) must also be removed from said agent in regeneration unit (8), it is possible to carry out this step without steam as stripping agent, because the lighter EGDMEs are distillable as distinct from the normally used scrubbing agents. This constitutes a further advantage of the invention as it is not necessary to provide a downstream step for removing from the scrubbing agent, any water introduced with the stripping steam.

1-4. (canceled)

5. A method for removing gas components from technical gases, whereby the gas components are scrubbed from the technical gas and the components are removed from the scrubbing medium laden with the gas components in a separate regeneration process after the scrubbing, whereby the scrubbing agent used is an ethylene glycol dimethyl ether or a mixture of different ethylene glycol dimethyl ethers, which scrubbing agent has a solidification point below −30° C. and a boiling point at normal pressure below 275° C. and a molar mass less than 230 g/mol, wherein the gas components are removed in a scrubbing at a temperature from −20° C. to −60° C.

6. The method as claimed in claim 5, wherein mono-, di-, tri- and tetra-ethylene glycol dimethyl ether or mixtures thereof are used as the scrubbing agent.

7. The method as claimed in claim 6, wherein di- and tri-ethylene glycol dimethyl ether or mixtures thereof with an average molar mass of 134 to 178 g/mol are used as the scrubbing agent.

8. The method as claimed in claim 5, wherein the scrubbing to remove the gas components takes place at a temperature of −20° C. to −40° C.

9. The method as claimed in claim 6, wherein the scrubbing to remove the gas components takes place at a temperature of −20° C. to −40° C.

10. The method as claimed in claim 7, wherein the scrubbing to remove the gas components takes place at a temperature of −20° C. to −40° C.
